(19) United States
(12) Patent Application Publication
(10) Pub. No.: US 2010/0127095 A1
(43) Pub. Date: May 27, 2010

(54) DEVICE FOR CONTROLLING A FLOW OF WATER, SPRINKLER PISTOL AND SYSTEM

(76) Inventor: Bernard Nicolas Vitkovsky, Janvry (FR)

Correspondence Address: ARENT FOX LLP, 1050 CONNECTICUT AVENUE, N.W., SUITE 400, WASHINGTON, DC, 20036, US

(21) Appl. No.: 12/597,849

(22) PCT Filed: Apr. 25, 2008
(86) PCT No.: PCT/FR08/00602

§ 371 Date: Jan. 27, 2010

(30) Foreign Application Priority Data
Apr. 27, 2007 (FR) 0754769

(51) Int. Cl. B67D 7/08; B05B 9/01

(52) U.S. Cl. 239/71; 239/526

(57) ABSTRACT

The present invention relates to a device for controlling the water flow rate, notably when using a garden hose. The invention more particularly relates to a device (1) for controlling a flow of water, for example in the form of a sprinkler pistol, comprising: a pipe (20) for transmitting a flow of water between an inlet end (21) arranged to be connected to a garden hose (5) and an outlet end (10), and means (9) of measuring the quantity of water circulating in the pipe (20). The device also comprises interruption means (18) arranged to interrupt the circulation of said flow inside said device (1) when the quantity of water measured by said measurement means is greater than a first value.

The present invention relates to a device for controlling a flow of water, more particularly when using a garden hose and more particularly a device for controlling a flow of water including
a pipe for transmitting a flow of water between an inlet end arranged to be connected to a garden hose and an outlet end, and
means for measuring the quantity of water circulating in the pipe.

The invention also relates to a sprinkler pistol which can be connected to a garden hose as well as a system composed of such device and a recharging base.

Such a device for controlling a flow of water is already known from the application for a patent FR-2 854 457 in the form of a sprinkler pistol, wherein a through flow of water rotates a caster actuating a system for measuring the quantity of water going through the pistol. The latter is provided with a display system displaying, in real time, the flow of water and an alarm emitting a sound signal when each desired measuring unit is reached. This device more particularly enables the user to accurately control his or her consumption of water and prevent any wasting of water. For this purpose, the sound alert gives useful information to the user.

Nevertheless, this system looses efficiency in a noisy environment, for example if a lawnmower is operated nearby. Further, the user may have a significant reaction time or be distracted which entails an excessive consumption with respect to the desired quantity of water.

With this object in mind, a first object of the invention consists in providing a reinforced control of the flow of water going through the garden hose.

Another object of the invention consists in automatizing the control of the flow of water. Then, the user's reaction time will no longer be a factor affecting the accuracy of the watering.

For this purpose, the invention first aims at a device for controlling the flow of water including
a pipe for transmitting the flow of water between an inlet end arranged to be connected to a garden hose type and an outlet end, and
means for measuring the quantity of water circulating in the pipe.

The device further includes interruption means arranged to interrupt the circulation of said flow inside said device when the quantity of water measured by said measurement means is greater than a first value.

The measure of the quantity of water can be considered as a measurement of a volume of water circulating from a preset moment, for example the resetting of a counter, or as a measurement of a flow rate corresponding to the quantity of water circulating at a given time.

The means for interrupting the flow of water block the circulation of water when the volume used reaches the preset value. Thus, the user is sure to supply the maximum of the desired volume of water even though he or she goes on actuating the water delivery system downstream of the control device.

The device according to the invention can be implemented in various forms:
a sprinkler pistol provided with an interruption system, or
a small water controller which is interconnected either between two parts of the garden hose, or between the hose and the sprinkler pistol (or any other terminal equipment of the watering system).

Various embodiments of the interruption means, which can be combined, can be considered.

According to a first alternative solution, said device includes a trigger having at least a first locking position in which no flow of water circulates in said pipe and a flowing position in which a flow of water circulates in said pipe, the switching from the first position to the second position being carried out by a user pressing said trigger, said interruption means being then arranged to position said trigger in said first position when said measured quantity of water is greater than said first value. Said interruption means optionally include an actuator, for example a fluid actuator driven jack or an electromagnetic actuator driven jack.

In this configuration, the trigger is directly used to regulate the circulation of the flow of water in the pistol to interrupt it when necessary. Then a separate system for regulating the flow is no longer necessary.

According to another alternative solution, said interruption means include an additional valve positioned in the path of said pipe, with said valve having at least an open position to enable the circulation of said flow of water in the pipe and a closed position to interrupt the circulation thereof.

According to another alternative solution, said interruption means include a valve for example a diaphragm valve positioned in the path of said pipe.

These two alternative solutions use specific components for the control of fluids.

Said interruption means can be controlled through driving electronic means processing the measurement signals.

In order to obtain an acceptable accuracy for the measurements of a quantity of water, said measuring means include a flowmeter to measure the instrument flow rate of the flow of water.

It is also provided for said measuring means to include an electronic measuring circuit arranged to determine a volume of water from the flow measurement generated by said flowmeter. These are simple mathematical integrations that the persons skilled in the art will know how to use when programming an ad hoc electronic circuit.

In one embodiment, said flowmeter is provided with an alternator to supply said electronic circuits and means. According to this configuration, the device of the invention is self-sufficient as regards power.

Using such a flowmeter as an alternator with any type of sprinkler pistol can also be considered whether interruption means of the present invention are present or not.

To also provide self-sufficiency when no flow of water circulates in the pipe and thus supplies the alternator, it is also provided for the device further to include an electric accumulator supplied by said alternator, with said electric accumulator being arranged to supply said electronic circuit and means. The electronic circuit and any display component which could be linked thereto, for example to set the device, are then continuously supplied.

In one embodiment enhancing the customisation of the device, more particularly to have it adapted to the requirements of the plants to be watered, means for programming at least one value and means for selecting said first value among the programmed values are provided in the device. The user has then the opportunity of programming various threshold values for various utilisations and select the one he/she wants according to his or her work.

Such values are more particularly stored in a memory of the electronic circuit.

Such a programming and memory system could be advantageously used with a device equivalent to the one described in the above mentioned application Fr-2 854 457, whether interruption means according to the present invention are present or not.

According to one embodiment, said measuring means generate a measured volume of water and the device further includes a display arranged to display said measured volume of water.

According to one embodiment, said measuring means generate a measured volume of water, with the device further including a reset button for resetting said measured volume of water.

The invention also relates to a system including a device provided with an accumulator according to the invention and a charging base,

said device further including external means for an electrical connection linked to said electrical accumulator,

said base including electric connection means connected to an electric power supply and the base being so arranged as to receive said device in a storage position, so that said connection means of said base cooperate with said connection means of said device to recharge the accumulator.

The invention also provides a sprinkler pistol including a control device as shown hereabove and means for generating a jet of water at the outlet end.

The advantages of the invention relate to three aspects:
an environmental aspect: knowing, in real time, the consumption of water as well as having the possibility of programming it make it possible for the user to no longer waste water, since only the required quantity is used;
an economical aspect: when limiting himself or herself to the required quantity of water, the user efficiently reduces his or her consumption of water and saves money on his or her water invoice;
a functional aspect: the device according to the invention enhances daily life when using a garden hose (for watering vegetables, small works requiring a very precise volume of water such as painting, plastering, cementing, coating).

The invention will be better understood using the following description, given hereinunder strictly for explanation purposes, of an embodiment of the invention and referring to the appended drawings on which:

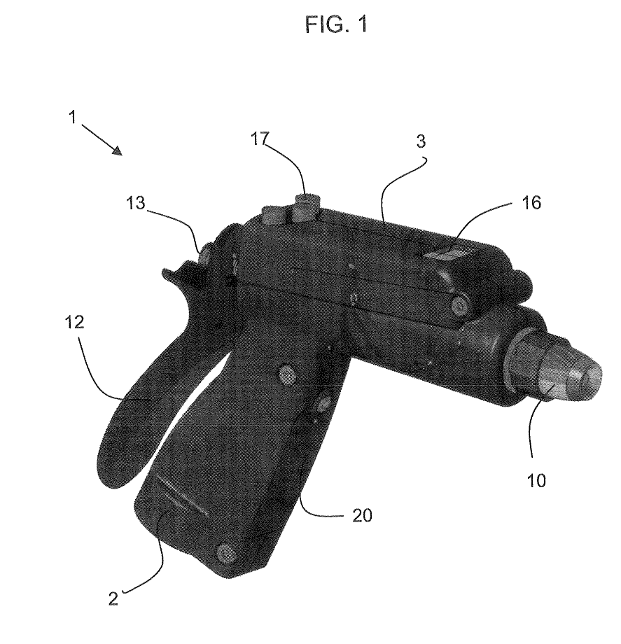

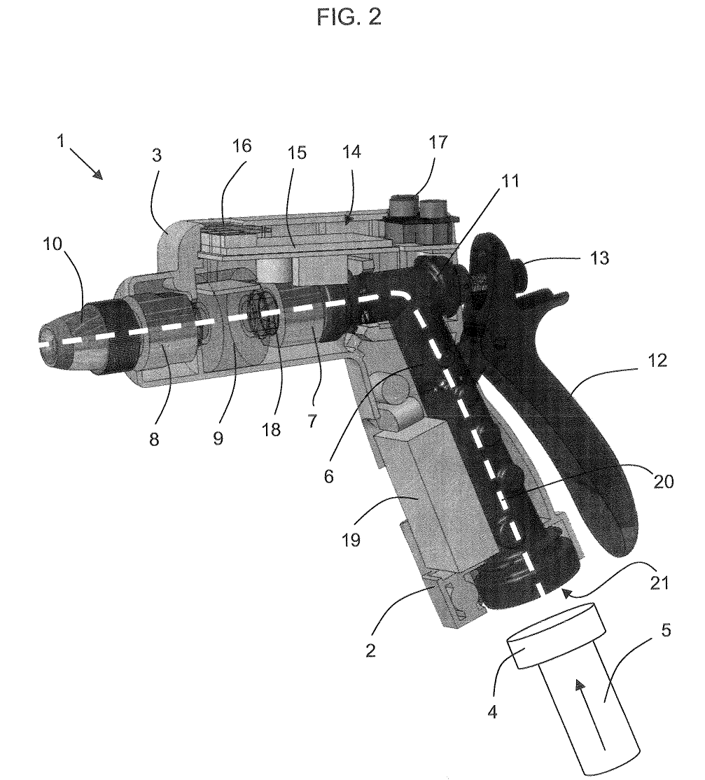

FIGS. 1 and 2 show a pistol according to the invention; and

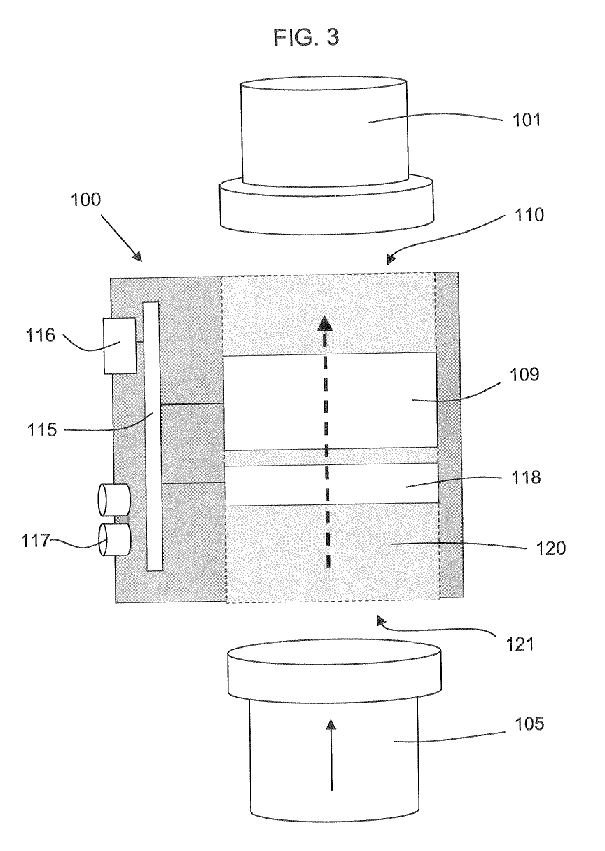

FIG. 3 illustrates another embodiment of the invention in the form of a connection means for a garden hose.

While referring to FIGS. 1 and 2, the pistol 1 according to the invention includes two half-shells made of hard plastic and closed to form the body of the pistol with a handle area 2 and an upper part 3.

The lower part of the handle includes a female plug for receiving a quick-action connector 4 linked to a garden hose 5. A female plug and a quick-action connector 4 are of the known type for the already existing watering equipment.

A circulation pipe (white discontinuous line 20) of the water supplied through the pipe 5 is formed within the body of the pistol 1 through a moulded part 6, metal rings 7, 8 respectively carrying a flowmeter 9 and a delivery nozzle 10 (including means for adjusting the outlet jet) of a known type.

These elements forming the pipe are sealed together to provide the sealing of the pipe 20.

The moulded part 6 is bent at the level of the area connecting the handle 2 and the higher part 3 and receives a mechanism for regulating 11 the flow of water circulating inside and mechanically controlled by a trigger 12 outside the body 2, 3. A screw for adjusting 13 the constraints of the trigger 12 on the regulation mechanism 11 is provided in the upper part of the trigger to preset the flow rate which can be obtained by actuating the trigger 12.

The flowmeter 9 is a flowmeter manufactured by the Parker Company and called Dataflow Compact (trade names) or any other flowmeter adapted to a utilisation according to the present invention. An alternator (not shown) is positioned adjacent to the flowmeter 9 in a configuration where the axis of the alternator is aligned and cooperating with the rotor of the flowmeter 9. The alternator generates an electric current when the flowmeter is gone through by a flow of water.

The upper part 3 of the pistol 1 includes a recess 14 for accommodating a printed circuit 15. This circuit includes programmed means of the ASIC type, and a memory (not shown) for storing variable data used when operating the pistol according to the invention. The circuit 15 includes specialised portions (hardware areas or software applications) for managing the various entities of the pistol: measurement, supply, display, user interface, recharging, etc.

The printed circuit 15 is connected to the flowmeter 9, to the alternator, to a display 16 visible on the upper surface of the pistol 1 and to control buttons 17 also accessible on this upper surface.

For implementing the invention, a diaphragm valve 18 is provided sealingly between the ring 7 and the flowmeter 9. The valve 18 is connected to the electronic circuit 15 for receiving control signals.

An electric power accumulator 19 of the battery type known to the persons skilled in the art is positioned in the handle 2 of the pistol 1. A plate 20 is screwed on the handle and gives access to this battery 19, for example to replace it. The battery 19 is connected to the electronic circuit 15, so as to provide an electric power supply to all the electric components 16, 17, 18 of the pistol 1.

In operation, a user sets the circuit 15 of the pistol 1 with several values of a volume of water he/she wishes to use for watering his or her various plants. This setting can be carried out by an external computer through a connection and a USB device (not shown) connected to a circuit 14 or through a dedicated interface on the pistol 1, for example a touch screen or selection keys. The various utilisation values are stored in a memory of the circuit 15, for example memory n° 1=garden watering, memory n° 2=balcony watering, memory n° 3=car washing, memory n° 4=utilisation of the sprinkler pistol from a date X, etc.

The user then selects, among these memories, the one corresponding to the desired program for example through a control button 17 having several positions (one position per memory).

When the user presses the trigger 12, the regulation mechanism 11 lets water circulate in the pipe 20 through the pistol 1 from the inlet 21 of the pipe up to the outlet of the nozzle 10 type. The valve 18 is a flowing valve and the delivery nozzle 10 is regulated to let water circulate. The flowmeter 9 measures, in real time, the flow rate of the flow of water circulating in the pipe. The measured values are processed by the circuit 15 to calculate the volume of water circulating since the last resetting of the counter.

The resetting of this counter can be carried out using one of the control buttons 17. The circuit resets the active counter at the moment of the resetting and increments it when and as measurement signals are received.

In parallel, the value of the active counter is displayed on the digital display system 16.

The value of the active counter is saved in the memory when the user changes the watering program.

The circuit 15 continuously compares the active counter incremented with the value stored in the memory selected by the user.

When the active counter reaches the value stored in the memory, the circuit 15 commands the closing of the valve 18 so as to lock the circulation of water in the pipe.

A sound alert can be emitted at that moment.

A sound pre-alert can also be emitted to inform the user that only a small quantity of water, for example 2 litres, is left before reaching the value stored in the memory. The user can thus adapt the watering to make sure that all the parts from the plant concerned are watered. This value of 2 litres can be defined by the user.

To unlock the valve, the user can release the trigger 12. Means detecting this release can be provided and inform the circuit 15 through a control signal to reopen the valve 18.

The release can also be carried out by pressing on a control button 17 connected to the circuit 15. The counter reset key also releases the valve 18.

In an alternative solution to the utilisation of a diaphragm valve, a servomotor or a hydraulic jack (not shown) driven by the circuit 15 can also be provided in the handle 2 of the pistol 1. When the circuit 15 emits a flow locking signal, the servomotor or jack mechanically pushes the trigger 12 to the rest position corresponding to the closed condition of the regulation mechanism 11.

When water does not circulate in the pistol (the user has not actuated the trigger 12 or the valve 18 is a locking valve), the circuit 15 and the electric components are supplied by the battery 19.

When water circulates in the pistol 1, the alternator transforms the rotative energy of the flowmeter 9 rotor which it is coupled to into electric energy supplying the circuit 15. The latter distributes the produced energy to the various electric components. The circuit 15 also behaves like a battery charger to recharge the battery 19 when an excess electric energy (with respect to the consumption of the pistol components) is produced.

The supply of the electronic system thus becomes totally self-sufficient, since the device collects the energy produced by the flowmeter (dynamo system). This energy produced is stored in an internal battery. The utilisation of a conventional battery (of the alkaline, lithium battery, or rechargeable cell battery types) is no longer necessary for the operation which becomes environment friendly.

A base (not shown) of the wall support type is provided to carry the pistol 1 when it is not used.

The handle 2 of the pistol 1 has two connection tabs (not shown) connected each to a different pole of the battery 19. When the pistol 1 is plugged in the base, both tabs come in electric contact with two matching tabs provided on the base and connected to the general electricity network.

When positioned in the base, the battery 19 of the pistol 1 is recharged.

The base also includes an electronic circuit controlling the recharging of the accumulator 19.

In a simplified version shown in FIG. 3, the device 100 is a connection ring made of a rigid plastic between the first hose 105 and the second hose or a pistol (or any other downstream sprinkler equipment) 101 through a female plug/quick-action connection system already known.

The device includes a flowmeter 109 and a valve 118 on the pipe 120 connecting the inlet 121 and the outlet 110 of the ring. An external display 116, external control buttons 117 are connected to an electronic circuit 115 inside the device 100. The operation is similar to that described while referring to the pistol 1. An alternator and possibly a battery are provided for supplying the electric system of the device 100.

If there is no trigger, the valve is unlocked using control buttons 117.

Other improvements of the device can be provided, such as for example:
the pistol provided with an electronic system integrates several sprinkler programs like: simple measurement of the delivered volume, predefined volume of water with automatic stop, predefined volume of water with sound and visual signal upon each multiple of the set point;
the new device is provided with a standby function. In case of an extended absence of utilisation, the system is automatically switched to standby;
whatever the display (digital, liquid crystal, etc.) it has a day/night display mode so that the pistol can be used at any time.

1. A device (1, 100) for controlling a water flow rate including
a pipe (20, 120) for transmitting a flow of water between an inlet end (21, 121) arranged to be connected to a garden hose (5, 105) and an outlet end (10, 110), and
means (9, 109) for measuring the quantity of water circulating in the pipe (20, 120),
characterised in that it further includes interruption means (18, 118) arranged to interrupt the circulation of said flow inside said device (1, 100) when the quantity of water measured by said measuring means is greater than a first value, the measurement of the quantity of water being selected between that of a volume of water circulating from a preset moment and that delivered at a given time.

2. A device (1) according to claim 1, comprising a trigger (12) having at least one first locking position in which no water flow circulates in said pipe (20) and a flowing position in which a water flow circulates in said pipe (20), the switching from the first position to the second position being carried out by a user pressing said trigger (12), said interruption means (18) being so arranged as to position said trigger (12) in said first position when said measured quantity of water is greater than said first value.

3. A device (1, 100) according to claim 2, wherein said interruption means (18, 118) include an electromagnetic actuator.

4. A device (1, 100) according to claim 1, wherein said interruption means (18, 118) include a valve positioned in the path of said pipe (20, 120), said valve having at least an open position to enable the circulation of said water flow in the pipe and a closed position to interrupt the circulation thereof.

5. A device (1, 100) according to claim 1, wherein said interruption means (18, 118) include a diaphragm valve positioned in the path of said pipe.

6. A device according to any one of claim 1, 2, 3, 4, or 5, including electronic means for driving (15, 115) said interruption means (18, 118).

7. A device (1, 100) according to claim 1, wherein said measuring means include a flow rate meter (9, 109).

8. A device (1, 100) according to claim 7, wherein said measuring means include a measuring electronic circuit (15, 115) so arranged as to determine a volume of water from measurements generated by said flow rate meter (9, 109).

9. A device (1, 100) according to one of claim 7 or 8, wherein said flow rate meter (9, 109) is provided with an alternator to supply said electronic circuit and means (15, 16, 115, 116).

10. A device (1, 100) according to claim 9, further including a rechargeable electric accumulator (19) so arranged as to be recharged by said alternator and to supply said electronic circuit and means.

11. A device (1, 100) according to any on claim 1, further including means for programming at least one value and means for selecting said first value among the programmed values.

12. A device (1, 100) according to claim 11, including a memory so arranged as to store said at least one programmed value.

13. A device (1, 100) according to claim 1, wherein said measuring means generate a measured volume of water, with the device further including a display (16, 116) so arranged as to display said measured volume of water.

14. A device (1, 100) according to claim 1, wherein said measuring means generate a measured volume of water, with the device further including a reset button (17, 117) for resetting said measured volume of water.

15. A system including a device (1, 100) according to claim 10 and a charging base,
said device (1, 100) further including external means for electric connection linked to said electric accumulator (19), said base including electric connection means linked to an electric power supply network and being so arranged as to receive said device in the recharge position so that said connection means of said base cooperate with said means for the connection of said device to recharge said accumulator (19).

16. A sprinkler pistol (1) including a control device according to any one of claim 1, 2, 3, 4 or 5, and means (10) for generating a jet of water at the outlet end (10).
